(19) United States
(12) Patent Application Publication
(10) Pub. No.: US 2026/0296637 A1
(43) Pub. Date: Oct. 1, 2026

(54) IMPROVED METHOD FOR DETERMINING A DESCENT TRAJECTORY FOR AN AIRCRAFT, DEVICE FOR CARRYING OUT THE METHOD, AND AIRCRAFT

(71) Applicant: AIRBUS OPERATIONS SAS, Toulouse (FR)

(72) Inventors: Sylvain RAYNAUD, Toulouse (FR); Charles RENAULT LEBERQUER, Toulouse (FR); Thomas D'ARMARGNAC, Toulouse (FR); Alexandre BUISSON, Toulouse (FR)

(73) Assignee: AIRBUS OPERATIONS SAS, Toulouse (FR)

(21) Appl. No.: 19/630,141

(22) Filed: Mar. 26, 2026

(30) Foreign Application Priority Data
Mar. 31, 2025 (FR) 2503322

(51) Int. Cl. B64C 13/18; G08G 5/21; G08G 5/23; G08G 5/54

(52) U.S. Cl. CPC B64C 13/18; G08G 5/21; G08G 5/23; G08G 5/54

(57) ABSTRACT

A method for determining a continuous descent profile for an aircraft to an arrival point, said method includes breaking down a continuous descent profile into a plurality of descent trajectory segments, whereby each descent trajectory segment is associated with a local descent trajectory correction strategy selected among a plurality of predetermined descent trajectory correction strategies. The invention also relates to a device carrying out the method. The method advantageously makes it possible to satisfy all predefined altitude and speed constraints for an approach to airport facilities to which an aircraft is heading.

### TECHNICAL FIELD

The present invention relates to a method for determining a continuous descent trajectory for an aircraft flying towards airport facilities, considering procedural, speed and altitude constraints. The invention relates more particularly to a method for determining a vertical continuous descent profile for an aircraft that aims to comply with approach, altitude and speed procedural constraints by giving preference to the use of reduced engine thrust. At least one embodiment aims to determine, for each of the segments of an envisaged descent trajectory, whether an increase in thrust or drag is required, and if so at what one or more times, and whether altitude and speed constraints are able to be complied with.

### PRIOR ART

Aircraft in flight, in particular airliners, are constrained, unless exceptionally authorized, to comply with pre-established descent and approach procedures when approaching and arriving at airport facilities. Descent and approach procedures make it possible in particular to organize, with the support of air traffic control services, separation of air traffic or, in other words, to organize a spacing between aircraft evolving in the same air sector. These procedures also aim to make accessible the use of radionavigation means useful for the arrival of aircraft conducting instrument flight phases, such as radio beacons or reference localization points for example. Ultimately, these procedures aim to reduce noise pollution for populations, and in particular those whose homes are close to aircraft trajectories and therefore often close to airport facilities. Thus, in addition to predetermined departure and arrival trajectories, comprising altitude constraints for one or more given locations referenced for example according to their respective projections onto the ground, speed constraints are defined so as to reduce noise pollution and particulate emissions resulting from combustion in engines. Defined and published approach procedures are designed to reconcile altitude and speed constraints based on the average performance of the aircraft that will use them. It is therefore possible, more often than not, to comply with the constraints inherent to these procedures, for a given procedure followed by a given type of airliner. The increasing use of continuous descent approach profiles, also known as CDO (continuous descent operations) or CDA (continuous descent approach), makes it possible to conduct a descent without intermediate flight levels, so as to reduce engine thrust as far as possible in an idle configuration, for which engine thrust is defined as being a minimum thrust below which, for safety reasons, an aircraft engine must not operate. A descent profile CDO defined as “unconstrained” is thus a profile comprising a succession of descent trajectory segments that, when traversed by an aircraft, respectively imply constant-speed evolution or a deceleration phase. However, depending on the type of aircraft, the performance of an aircraft at a specific time and the conditions of evolution, in particular due to meteorological conditions (wind, temperatures, etc.), it is possible that all constraints as defined by an approach procedure might not be able to be complied with without at least moderately acting on engine thrust or without carrying out controlled deceleration at selected times. In addition, trajectory segments corresponding to a deceleration must be short in order to meet requirements in terms of estimating average speed and flight time in relation to air traffic control and traffic separation, in addition to being able to provide pilots with a better sensation of variations in flight parameters, which is important in terms of aircraft piloting.

The situation could be improved.

### SUMMARY OF THE INVENTION

One object of the present invention is to propose an optimized method for determining a continuous descent profile for an aircraft that makes it possible to satisfy all constraints relating to a descent approach of an aircraft towards airport facilities, quickly and while requiring limited computing power.

To this end, what is proposed is a method for determining a continuous descent profile for an aircraft towards a point of an arrival procedure referred to as an “arrival point” or “end point”, the method comprising:
i) determining segments of an initial continuous descent profile based on at least the arrival point, predefined speed constraints and theoretical data concerning the evolution of the aircraft conducting a flight with minimum engine thrust,
ii) categorizing each of said determined segments of said initial profile among a plurality of predetermined energy level categories, based on at least said predefined speed constraints and altitude constraints, and
iii) determining, for each of said categorized segments, a local strategy for modifying said initial continuous descent profile, based on an energy category assigned to the segment in question, said local strategy aiming to determine, if necessary, times at which to increase the thrust and/or drag of said aircraft.

The use of the described method advantageously makes it possible to satisfy a maximum number of predefined altitude and speed constraints for an approach to airport facilities towards which an aircraft is heading, while using limited computing means.
The method according to the invention may furthermore have the following additional features, considered alone or in combination:
   The method furthermore comprises, following the determination of a local strategy for each of the segments:
iv) computationally determining a final continuous descent profile according to the concatenated results of the determined local strategies respectively applied to the segments, for the purpose of detecting the absence of incompatibility between the determined final continuous descent profile and at least one of the predefined speed constraints or altitude constraints, and then,
v) in the absence of incompatibility between the determined final continuous descent profile and at least one of the predefined speed constraints or altitude constraints, controlling a trajectory of the aircraft in accordance with the final continuous descent profile or providing piloting information representative of piloting actions to be carried out to conduct a continuous descent in accordance with the final continuous descent profile.
   The method comprises at least three predefined local strategies for modifying a descent profile, including:
a) a first strategy, called “low-energy” strategy, involves maintaining the speed of the aircraft with engine thrust applied while traversing a segment portion less than the length of the segment in question,
b) a second strategy, called “high-energy” strategy, involves activating drag-increasing devices only during a deceleration portion less than the length of the segment in question,
c) a third local strategy, called “very high-energy” strategy, involves activating drag-increasing devices during a portion of the segment in question greater than the deceleration portion.
   The method comprises a fourth local strategy, which involves activating drag-increasing devices during a portion of the segment in question greater than the deceleration portion and less than or equal to the length of the segment.
   The method comprises a fifth local strategy, which involves activating drag-increasing devices throughout the length of the segment in question and reducing the deceleration to less than that desired.

Another object of the invention is a device for controlling a continuous descent trajectory of an aircraft, the device comprising electronic circuitry configured to:
i) determine segments of an initial continuous descent profile based on at least the arrival point, predefined speed constraints and theoretical data concerning the evolution of the aircraft conducting a flight with minimum engine thrust,
ii) categorize each of the determined segments of the initial profile among a plurality of predetermined energy level categories, based on at least the predefined speed constraints and altitude constraints, and
iii) determine, for each of the categorized segments, a local strategy for modifying the initial continuous descent profile, based on an energy category assigned to the segment in question, the local strategy aiming to determine, if necessary, times at which to increase the thrust and/or drag of the aircraft.

The device according to the invention may furthermore have the following additional features, considered alone or in combination:
The device furthermore comprises electronic circuitry configured to:
iv) computationally determine a final continuous descent profile according to the concatenated results of said determined local strategies, for the purpose of detecting the absence of incompatibility between the determined final continuous descent profile and at least one of said predefined speed constraints or altitude constraints, and then,
v) in the absence of incompatibility between the determined final continuous descent profile and at least one of said predefined speed constraints or altitude constraints, control a trajectory of the aircraft in accordance with the final continuous descent profile or provide piloting information representative of piloting actions to be carried out to conduct a continuous descent in accordance with the final continuous descent profile.
The device furthermore comprises electronic circuitry configured to carry out the local strategies described above by applying modifications of all or some of the determined trajectory segments and thus determining times at which to increase engine thrust, or times at which to increase drag, where applicable.

Another object of the invention is an autopilot system for an aircraft comprising a control device as described above.

The invention also relates to an aircraft comprising an autopilot system for an aircraft as mentioned above or a control device as described above.

Finally, the invention also relates to a computer program product comprising program code instructions for carrying out the steps of a method as described above when the instructions are executed by a processor of an aircraft control device, and to a storage medium comprising such a computer program product.

### BRIEF DESCRIPTION OF THE DRAWINGS

The abovementioned features of the invention, along with others, will become more clearly apparent upon reading the following description of one exemplary embodiment, said description being given with reference to the appended drawings:

FIG. 1 schematically illustrates a segmented portion of a continuous descent trajectory (or profile) of an aircraft towards airport facilities, according to one embodiment;

FIG. 2 is a depiction of the vertical component of an aircraft trajectory comprising a segmented portion of a continuous descent trajectory already shown in FIG. 1;

FIG. 3 schematically illustrates the aircraft trajectory already shown in FIG. 2 associated with local speed and altitude constraints, when all constraints are satisfied;

FIG. 4 schematically illustrates the aircraft trajectory already shown in FIG. 2 associated with local speed and altitude constraints, when one or more constraints are not satisfied;

FIG. 5 schematically illustrates one example of an internal architecture of a device for determining an aircraft continuous descent profile;

FIG. 6 schematically illustrates an aircraft comprising the device for determining a continuous descent profile already shown in FIG. 5; and

FIG. 7 schematically illustrates a method for determining one or more continuous descent profiles for an aircraft, able to be carried out by the device already shown in FIG. 5.

### DETAILED DESCRIPTION OF EMBODIMENTS

FIG. 1 is a schematic and perspective depiction of airport facilities 1 from and to which aircraft are able to evolve in compliance with regulations or procedures specific to air transport. The airport facilities 1 occupy a substantially flat area of land 1g. The area of land 1g comprises a runway 19 for aircraft, also usually referred to as a take-off and landing runway, and designed to allow take-off and landing operations for aircraft suitable for this runway 19. The aircraft runway 19 is located close to an end point A, which constitutes a final navigational landmark for aircraft flight crews to conduct final landing manoeuvres on the runway 19, following a predefined descent and approach phase towards the runway 19. An aircraft landing is always preceded by a descent and approach phase towards the destination airport facilities, aside from any emergency procedures. Such a descent and approach phase is defined as an intermediate flight phase between cruising and landing of an aircraft. A descent and approach phase satisfies descent and approach procedural constraints, and one or more descent and approach procedures may be predefined for the same runway, depending for example on the type of aircraft, the type of flight being conducted (commercial, private, civil, military, etc.), ongoing activities, or even flying conditions, in particular local flying conditions.

An end portion of a continuous descent profile PI, determined for conducting an approach towards the runway 19, is illustrated in FIG. 1. This end portion of the profile PI comprises multiple descent and approach segments delimited by speed constraints (or imposed speeds). Each of the segments delimited by speed constraints may comprise subsegments that may each be characterized by a descent slope.

For example, a first subsegment of a segment may be traversed by an aircraft descending along a first slope having a first angle (or rate) of descent, and a second subsegment of the same segment may be traversed by this aircraft descending along a second slope having a second angle (or rate) of descent.

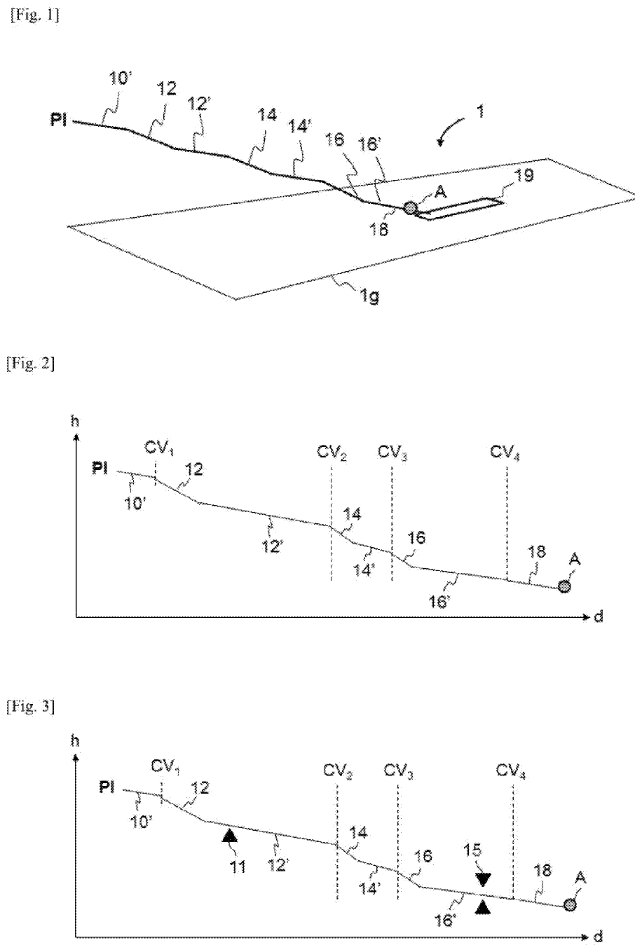

According to the exemplary descent profile PI illustrated in FIG. 1, subsegments 12, 14 and 16 of a continuous descent profile have a first angle of descent at which, for a given aircraft, the rate of descent is constant when the reduced thrust of this aircraft is at a minimum in an engine thrust configuration called idle, and subsegments 10′, 12′, 14′, 16′ and 18 have a second angle of descent at which, for the same aircraft, the speed of the aircraft decreases. Thus, and still according to the exemplary continuous descent profile PI illustrated in FIG. 1, the subsegments 12 and 12′ together (jointly) form one segment of the descent profile between two successive speed constraints, the subsegments 14 and 14′ together form another segment of the descent profile between two successive speed constraints and the subsegments 16 and 16′ together form yet another segment of the descent profile. The subsegment 10′ is a speed reduction subsegment of an initial segment considered in the continuous descent profile PI according to the example described, and the subsegment 18 is a subsegment of a final segment of the descent profile. According to one embodiment, a segment may consist of a single subsegment, provided that the constraints to be satisfied when an aircraft evolves along this profile segment are complied with. The speed constraints mentioned above are not illustrated in FIG. 1 for the sake of simplification, but are visible in FIG. 2.

For the sake of simplification, only the abovementioned segments of the descent profile PI are illustrated in FIG. 1, but the descent profile PI may of course comprise many other higher segments, including in particular curved trajectory segments, turns, holding loops, descent loops, delay turns, etc. The term “segment” here designates a continuous descent trajectory portion for which, in the present description, variations in speed and variations in altitude of an aircraft traversing this continuous descent trajectory portion towards the runway 19 are of interest. The projection of a descent segment onto the ground may thus be either a straight line or a curve, and the projection onto the ground of an aircraft evolving along the trajectory portion described by one or more segments is defined as a “curvilinear abscissa”.

According to one embodiment, the continuous descent profile PI is determined first with a first level of precision, computationally, based on a plurality of predefined speed constraints according to an arrival procedure with which the aircraft must comply. Next, the continuous descent profile PI is refined (modified if necessary), again computationally, based on altitude constraints and waypoints (a route) that comprises predefined trajectory portions, that is to say for example minimum approach flying altitudes, maximum approach flying altitudes, airway boundaries, theoretical volumes of air traffic control zones (CTR, terminal manoeuvring area (TMA), etc.), identified obstacles, and meteorological conditions, including in particular wind strength and direction at various altitudes, the weight of fuel, passengers and cargo, for example.

The continuous descent profile PI is first determined by integrating the movement of the airliner by traversing the profile “backwards” (in accordance with a set of calculations referred to as backward integration), that is to say starting from the end point A and gradually going back, while proceeding via intermediate calculations, so as to satisfy all speed and altitude constraints. In other words, the intermediate calculations that are carried out aim to reach a higher point of the profile by first complying with the defined speed constraints and then, between two successive speed constraints (neighbouring in the descent profile), complying with the defined altitude constraints. These successive calculations are referred to as “idle calculations” here and take into account the performance of the airliner and the predetermined continuous descent slopes in accordance with an idle profile (that is to say constant-speed slopes and deceleration slope). According to one embodiment, the deceleration slope is determined so that 60% of the aircraft drag is useful for deceleration and 40% of the aircraft drag is useful for the descent.

The continuous descent profile PI is also determined based on the airliner's own performance, including in particular its average glide rate of descent and its maximum fineness speed. According to one embodiment, the continuous descent profile PI is calculated by one or more computers of an aircraft in question approaching the runway 19. According to one variant embodiment, the continuous descent profile PI is calculated by equipment remote from the aircraft heading for the facilities 1, for example a ground computer, and then transmitted to the aircraft preparing to conduct an approach towards the runway 19.

The continuous descent profile PI, also called the idle profile here, is thus initially calculated based on performance of the aircraft evolving with an engine thrust parameter equal to the minimum engine thrust authorized for the aircraft intended to use it, for the entire continuous descent trajectory. This configuration of the aircraft whereby the engine thrust is at a minimum is a configuration known as idle. An ideal continuous descent profile aims to conduct a stepless descent, ideally in an idle configuration from start to finish, so as to avoid the need for an engine thrust greater than idle engine thrust, and thereby to save energy, limit noise pollution and emissions of carbonaceous particles. The continuous descent profile PI is therefore determined by successive calculations, taking into account firstly the speed constraints determined for the arrival trajectories, and taking into account the meteorological conditions and the nominal and/or measured performance of the aircraft intended to use the continuous descent profile PI. According to one embodiment, the continuous descent profile PI is determined for each approach towards airport facilities, for each aircraft, starting from the end point A and taking into account procedural constraints, so as ultimately to arrive at a continuous descent profile starting point while still ideally complying with all listed constraints by successively using two descent slopes, one of which, substantially equal to 1° (or sometimes 1.5°), corresponds overall to effective deceleration, and another descent slope, of the order of 3°, corresponds overall to maintaining the speed of the aircraft.

Of course, in the final phases of flight upon arrival and in order to stabilize flight conditions before landing, adjustments may be required. Most of the time, the operations of piloting the aircraft on final approach and shortly before final approach to the arrival runway are conducted without an autopilot device, and the described methods then essentially concern the continuous descent flight phases between a descent start point up to the end point A.

FIG. 2 is a schematic depiction of the vertical component of the continuous descent profile PI determined by an aircraft according to one exemplary embodiment. The profile thus describes a path of the aircraft having a decreasing height h when the aircraft taking it traverses a horizontal distance d. The abovementioned subsegments 10′, 12, 12′, 14, 14′, 16, 16′ and 18 defined between a start of continuous descent and the end point A of the continuous descent schematically illustrate two types of descent slope. According to one embodiment, subsegments with a steeper slope have a slope of 3°, and subsegments with a less steep slope have a slope of 1°. In FIG. 2, the slopes are deliberately exaggerated for schematic purposes, enabling better legibility of the continuous descent profile PI illustrated therein. According to the example described here, the continuous descent profile PI must satisfy speed constraints CV₁, CV₂, CV₃ and CV₄ imposed by the published approach procedure and that must be complied with to descend to airport facilities 1, for example a regulatory procedure published by an authority. FIG. 2 illustrates, according to the example described, the fact that, in order to attain the speed constraint CV₁, the slope enabling a speed reduction must be followed by traversing the subsegment 10′. Similarly, in order to attain the speed constraint CV₂, the speed reduction slope must be followed by traversing the subsegment 12′. Again similarly, in order to attain the speed constraint CV₃, the speed reduction slope must be followed by traversing the subsegment 14′, and so on. The other subsegments may then be traversed by descending along a slope at constant speed. FIG. 2 thus illustrates five successive segments of the continuous descent profile PI, namely:
a first descent segment (10′), above the altitude (or height) of the trajectory point for which the speed constraint CV₁ is established,
a second descent segment (subsegments 12 and 12′), between the two continuous descent trajectory points for which the speed constraints CV₁ and CV₂ are respectively established,
a third descent segment (subsegments 14 and 14′), between the two continuous descent trajectory points for which the speed constraints CV₂ and CV₃ are respectively established,
a fourth descent segment (subsegments 16 and 16′), between the two continuous descent trajectory points for which the speed constraints CV₃ and CV₄ are respectively established,
a fifth descent segment (18) between the continuous descent trajectory point for which the speed constraint CV₄ is established and the end point A.

According to one embodiment, it is considered here that the determination of the descent trajectory of the aircraft below the end point A is part of the manual piloting of the aircraft conducting a landing phase on the runway 19 of the airport facilities 1.

FIG. 3 illustrates one example of altitude constraints 11 and 15 to be satisfied in the context of an arrival procedure to be complied with, according to one embodiment, by an aircraft descending towards the end point A. According to the example described, the altitude constraint 11 is an “at or above” constraint. This type of at or above altitude constraint means that an aircraft flying over the projection of the point in space for which the constraint is defined must evolve at an altitude greater than or equal to the altitude defined by the constraint. In other words, the aircraft must pass above the altitude or at the predefined altitude. Still according to the example described, the altitude constraint 15 is a combined “at or above” and “at or below” constraint, which is tantamount to defining a possible passage between two predefined altitudes. For example, a descending and approaching aircraft should not pass either too high, for example due to the presence of an air corridor reserved for particular uses (for example military activities), or too low, in order to reduce noise pollution for homes.

According to the example illustrated in FIG. 3, the determined continuous descent profile PI satisfies all the constraints present, namely the speed constraints CV₁, CV₂, CV₃ and CV₄ by virtue of the deceleration phases by traversing the subsegments with a lower slope, and the altitude constraints 11 and 15. For example, this is a combination of constraints for which the constraints have been established considering a given aircraft type (among others) and then ensuring that the constraints appear consistent with one another with respect to the nominal performance of this aircraft descending with minimum engine thrust (idle).

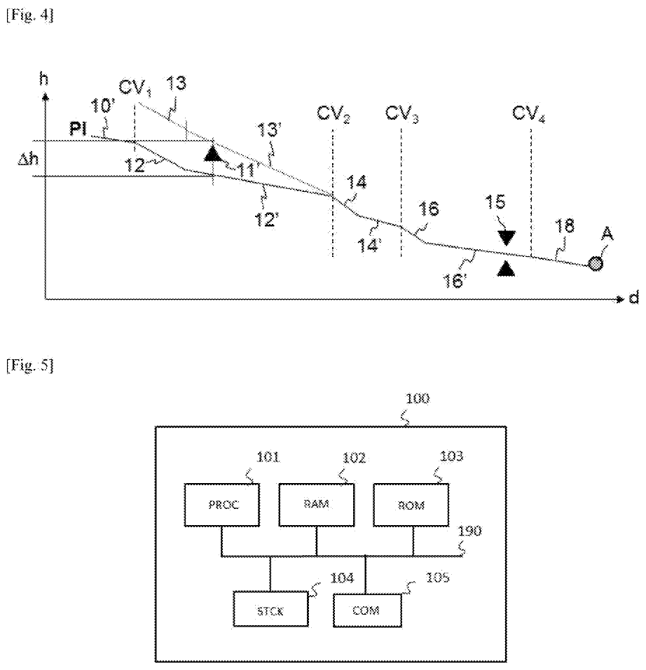

FIG. 4 is a schematic depiction of the vertical component of the continuous descent profile PI determined by an aircraft, according to another example, and in the case where the aircraft cannot comply with all existing speed and altitude constraints without making one or more modifications to the idle descent profile (the initially determined continuous descent profile PI). According to the example shown in FIG. 4, the published arrival procedure to be complied with comprises an altitude constraint 11′ higher than the constraint 11 presented according to the previous example illustrated in FIG. 3. It therefore appears that the constraint 11′ cannot be complied with here without modifying the initial continuous descent profile PI (idle), for example, because the approach and arrival procedures are not applicable to the aircraft in question or else, for example, because of singular external conditions, such as for example particular meteorological conditions. The continuous descent profile PI, however, satisfies the altitude constraint 15. It is then necessary to modify the continuous descent profile in order to satisfy the altitude constraint 11′. One example of such a modification is illustrated schematically by the definition, through simplified and fast calculations, of new subsegments 13 and 13′ between the speed constraints CV₁ and CV₂, that is to say by conducting for example a faster descent over the deceleration portion of the subsegment 13′, so as to comply with the altitude constraint 11′, and by conducting, beforehand, a descent at constant speed in the subsegment 13, preceding the subsegment 13′ in the direction of descent. More generally, if a modification of the segment 13′, prioritized as the highest deceleration segment, is not sufficient, then the slope of the lower deceleration segment is also increased. If this were still to prove insufficient, the slope of the following segment 16′ would also be increased, and so on. Such a modification of the continuous descent profile PI has the consequence of modifying the altitude of the point for which the speed constraint CV1 is established, this implying considering the difference in altitude Δh between the unconstrained continuous descent profile PI and the newly established continuous descent profile. This means that this difference (or jump) in height Δh must be considered when using integration to calculate the movement of the aircraft in question backward (going back in the opposite direction to the descent). Thus, when an initial continuous descent profile PI has to be constrained because at least one altitude or speed constraint cannot be complied with, the continuous descent profile PI must be modified by going back in the opposite direction to the descent, starting from the first constrained segment (that is to say the one comprising a constraint that cannot be complied with) and the cumulative variations in height Δh induced in the profile thus modified must be considered for the rest of the integration calculation (from the following segment in the direction of the backward integration process).

According to one embodiment, the simplified and fast calculations aimed at modifying the initial continuous descent profile PI in order then to be able to comply with one or more constraints that cannot otherwise be complied with are carried out based on a computing unit using data stored in a preloaded read-only memory or random access memory of a device for determining a continuous descent profile. The preloaded read-only memory or random access memory advantageously comprises tables and matrices of information and data capable of carrying out simplified and fast descent trajectory calculations, including using a backward integration method for the movements and displacements of the aircraft, in particular by carrying out calculations of affine functions and calculations of intersections of straight lines in a calculation space expressing heights (or latitudes) of the aircraft as a function of its displacement along a horizontal trajectory. In other words, these data and information constitute numerous calculation templates and numerous charts for carrying out fast and sufficiently precise calculations when determining local strategies (per segment and subsegment of the continuous descent profile), all while considering, if necessary, weights or other modification coefficients determined from obtained data representative of the flight conditions of the aircraft in question (temperature, reference atmospheric pressure, wind force and direction, heading followed, current altitude, etc.).

Cleverly, and according to one embodiment, each of the continuous descent profile segments to be modified is categorized according to the level of energy to be dissipated between the start of the segment and the end of the segment, or else over one or more subsegments of the segment in question. This advantageously makes it possible to define a local strategy for modifying the initially determined idle continuous descent profile.

Such a multi-segment strategy also makes it possible to dissipate an “over-altitude” or an “under-altitude” inserted into the modified continuous descent profile PI in order to be able to satisfy a constraint that might not be able to be satisfied without modifying the continuous descent profile PI. It is thus considered that the continuous descent profile is made up of k successive segments that, connected end to end, together make up the complete continuous descent profile to be followed in order to control the trajectory of the aircraft in question.

According to one embodiment, each of the k descent trajectory segments is associated with a local trajectory modification (correction) strategy among a plurality of predefined trajectory correction strategies, including:
a first trajectory correction strategy, called “low-energy” strategy, involves a phase of applying engine thrust for a duration less than the duration of traversal of the descent trajectory segment associated therewith,
a second trajectory correction strategy, called “high-energy” strategy, involves a phase of activating drag-increasing devices for a duration less than the duration of traversal of said descent trajectory segment associated therewith, and
a third trajectory correction strategy, called “very high-energy” strategy, involves a phase of activating drag-increasing devices throughout the duration of traversal of said descent trajectory segment associated therewith.

According to one particular variant embodiment, the second trajectory correction strategy, called “high-energy” strategy, involves a deceleration comprising a phase of activating drag-increasing devices for a duration of traversal of a subsegment of said segment associated therewith, and a phase of maintaining thrust or speed, comprising a phase of activating drag-increasing devices for a duration less than or equal to the time needed to traverse the subsegment remaining to be traversed in the segment in question.

According to one embodiment, the “low-energy” correction strategy involves limiting the loss of altitude, and this is controlled by reducing the descent slope while traversing a constant-speed segment portion (also called an isoCAS subsegment), before starting a deceleration subsegment.

According to one embodiment, when a strategy has been determined for processing a trajectory segment, that is to say for absorbing a share of an altitude differential Δh for this segment while satisfying the altitude and speed constraints, the segment may be “split” into at least two subsegments. One of the subsegments of the segment in question is used to maintain speed, and the other of the two subsegments of the segment in question is used to change speed.

It is possible to implement numerous optimization strategies per segment or per subsegment. For example, according to one embodiment, a low-energy strategy aims to minimize thrust without having to use drag-increasing devices, and a high-energy strategy aims to use idle engine thrust while using a minimum number of drag-increasing devices.

According to this embodiment, the high-energy strategy may be broken down into a medium-high-energy strategy that uses drag-increasing devices only when traversing some of the deceleration segments, and a very high-energy strategy that uses drag-increasing devices only when traversing all of the deceleration and speed-maintaining segments.

In the medium-high-energy strategy, the increase in drag is applied only in at least a subset of the deceleration portions.

In the very high-energy strategy, an increase in drag is applied during all deceleration portions, although this is not sufficient. It is then necessary to add additional drag in at least a subset of the constant-speed profile portions.

Advantageously, criteria concerning generated engine noise, travel time and fuel consumption may be integrated into the various processing strategies for a segment or subsegment.

According to one embodiment, a so-called medium-high-energy strategy consists in using an average level of deployment of drag-increasing devices to guarantee a fixed minimum deceleration rate combined with an elevated deceleration slope to satisfy a target altitude constraint.

According to one embodiment, a so-called medium-high-energy strategy consists in maintaining the slope of the constant-speed portions and in adding one of the additional drags to absorb the height differential delta h only over a subset of the deceleration portions of the profile (in fact, the use of drag increases the slope of the decelerated parts where it is appropriate to make a correction, while still maintaining an effective deceleration rate, to absorb the height differential delta h).

According to one embodiment, a so-called very high-energy strategy consists in using a median level (½, or in other words 50%) of deployment of drag-increasing devices in combination with a deceleration slope aimed at guaranteeing a minimum deceleration rate over all deceleration portions in question, and in using an average rate of deployment of drag-increasing devices over a determined subset of the constant-speed portions in order to fully absorb the height differential delta h. According to one embodiment, a continuous correction solution is used to be able to process any type of height differential delta h, this being tantamount to stating that additional drag is used continuously except for a final portion of the profile, in which a deployment of drag-increasing devices having a deployment stroke x of between 0% and 50% will be used. Indeed, a pilot is usually not familiar with an intermediate deployment (x) of drag-increasing devices, that is to say a deployment not corresponding to a predefined stroke of the control lever. This is why such a configuration is ideally limited to a single portion of the descent profile.

According to one embodiment, a so-called very high-energy strategy consists in using a median level (½) of deployment of drag-increasing devices in combination with a deceleration slope aimed at guaranteeing a fixed minimum deceleration rate and maintaining speed with a median level of deployment of drag-increasing devices (½) and maintaining speed without deployment of drag-increasing devices.

According to one embodiment, a so-called medium-high-energy strategy increases a descent slope while maintaining speed, provided that the airliner does not accelerate beyond a predefined limited speed.

Advantageously, data determined when determining the (initial) continuous descent profile PI are recorded in a computer memory of a device in the aircraft so as to be used when determining or implementing a strategy for optimizing a modified continuous descent profile P2, for example to determine phases in which to increase the engine thrust of the aircraft or to activate drag-increasing devices of the aircraft for a trajectory segment or else for a specific trajectory subsegment.

According to one embodiment, the “high-energy” correction strategy involves modifying the descent slope and acting on the length of a deceleration subsegment. For example, an evaluation is carried out when constructing the continuous descent profile P2 in order to verify whether the length of a deceleration subsegment may allow deceleration at a minimum deceleration rate with an aerobrake configuration whereby the aircraft drag-increasing device deployment setpoint is called “½” (deflection of drag-increasing devices with a setpoint at half their maximum output stroke). If the expected length of the deceleration subsegment does not make it possible to comply with both the target altitude and speed constraint, the start of the deceleration subsegment is modified considering a fixed deceleration rate lower than that defined before the modification (thereby making it possible to determine a steeper slope). Once the deceleration subsegment start has been calculated in this way, it is possible to comply with a speed profile that meets the constraints by deflecting the drag-increasing devices by an output amplitude between zero (drag-increasing devices retracted) and the 1/2 position (output setpoint position at half stroke).

According to one embodiment, in the so-called very high-energy correction strategy, the deceleration is determined with a fixed deceleration slope equal to the predefined deceleration limit slope of the aircraft, for a given deceleration rate. The adjustment variable becomes the length of this deceleration segment, which depends on the flight speeds at the start and end of the segment. It is possible to calculate the height of the high deceleration point, and therefore its position. Finally, if this speed reduction is not sufficient, it is also possible to use drag-increasing devices on a constant-speed part of the segment in question.

Thus, overall, the objective of such a multi-segment strategy is to dissipate an “over-altitude” or an “under-altitude” while still being capable, for the aircraft in question, of making effective speed changes capable of satisfying the predefined speed constraints. For this purpose, a local strategy for modifying the initial continuous descent profile PI is therefore determined locally, and for each of the segments delimited between two speed constraints, in order to preserve its operational properties as far as possible while still satisfying the predefined constraints. The modification strategy mainly uses a deceleration for the speed changes imposed in the segment being processed and the choice of the parts to be modified of the segment being processed in order to add engine thrust or drag where applicable. According to one embodiment, the deceleration strategy is processed as a priority in order then to process a problem with a single residual dimension: altitude.

According to another embodiment, more than three local modification strategies (modes) are used to modify the initial continuous descent profile PI.

According to one example, up to six strategies are predefined, so as to be able to quickly categorize a continuous descent profile segment and process it just as quickly.

These six local strategies for modifying the continuous descent profile are:
a so-called “low-energy” segment modification strategy,
a so-called “high-energy” segment modification strategy,
a segment modification strategy called “strategy based on alerts in a deceleration zone”,
a segment modification strategy called “strategy based on multiple decelerations”,
a so-called “very high-energy” segment modification strategy,
a so-called “path too steep” segment modification strategy.

### Regarding the So-Called “Low-Energy” Segment Modification Strategy

In this strategy, an altitude gain is obtained by reducing the descent slope of the constant-speed part of the profile as before modification of the segment. The deceleration start position as defined before modification of the segment is preserved. This strategy makes it possible to preserve the predefined decelerations over the segment and to distribute extra thrust over the constant-speed part, this corresponding, for a pilot, to maintaining speed by adding a little thrust.

From an operational point of view, the desired effect is to avoid a deceleration zone steeper than the constant-speed zone. Therefore, the slope of the constant-speed segment portion is equal to that of the decelerated-speed segment portion.

If such a configuration is not possible, a single local slope strategy is defined.

### Regarding the So-Called “High-Energy” Segment Modification Strategy

In this strategy, the adjustment variables are the slope and possibly the length of the decelerated portion of the segment. Steep slopes of constant-speed profile portions should be avoided because they result in accelerations until the pilot deploys drag-increasing devices of the aircraft. In addition, over a constant-speed portion of the segment, the sensation given to the one or more pilots is not satisfactory insofar as the airliner accelerates and does not maintain the desired speed. With excessive deployment of drag-increasing devices, the engines adjust the speed upwards and a phenomenon of additional thrust and additional drag in combination could occur.

The objective is thus to use a deployment of drag-increasing devices to a minimum extent so as to implement only the need for drag that is specifically useful. In addition, a pilot may be guided by the avionics system, but only for the application of a standard amount of drag (50% of the deployment stroke of the drag-increasing devices). It is therefore advantageous to minimize (or to attempt to minimize) occurrences of descent profile portions for which another deployment stroke is required (a modification strategy based on alerts is described below). Ultimately, it is not desirable for pilots to have to carry out recurring actions to add and remove drag. Thus, the ideal scenario is for only one drag addition action per segment to be required when additional drag is necessary.

### Regarding the Segment Modification Strategy Called “Strategy Based on Alerts in a Deceleration Zone”

This strategy of absorbing the altitude differential over the segment in question aims to use a deployment of drag-increasing devices in the deceleration zone, firstly of a predetermined amplitude less than 50% of the maximum deployment, and to calculate a speed drift iteratively and continuously in order to issue an alert to the pilot aimed at subsequently increasing the deployment of the drag-increasing devices. The pilot will then be able to actuate the drag-increasing devices with a deployment of 50% of the maximum stroke, at a precise time. If such deployment is not sufficient, the strategy then aims to increase the length of the deceleration segment, thereby advantageously making it possible not to deploy drag-increasing devices over the constant-speed segment portion. This principle may also be used if the chosen deceleration rate is lower than that of the initial profile (which could prove to be too high). In this case, the deceleration slope of the initial profile is maintained and its rate is high, unless deployment of drag-increasing devices at 50% of the maximum stroke is no longer sufficient. The rate of descent is then degraded by increasing the length of the deceleration. However, it is not possible to fall below a minimum rate, otherwise the deceleration portion would become abnormally long. In this case, the high energy is dissipated with a minimum slope rate as long as the drag-increasing devices allow, and then the rate is modified and then brought back to a minimum value.

### Regarding the Segment Modification Strategy Called “strategy Based on Multiple Decelerations”

In this strategy, the use of drag-increasing devices is applied as a priority during the highest deceleration phase (the one at the highest altitude in the segment). Advantageously, the pilot may, if necessary, apply further additional drag at the end of the segment. This makes it possible to use small additions of drag, for example in a smooth configuration or with limited deployment, thereby making it possible to avoid steep slopes. This advantageously makes it possible not to have to approach the final approach slope (or glideslope) arriving from above with a slope greater than 3° (that is to say with a descent slope greater than the glideslope). The final approach slope here is the reference slope during an arrival conducted with ILS (instrument landing system) on-board instruments. According to one embodiment, a particular local strategy is determined for the segment approaching the final approach slope (glideslope), aimed at guaranteeing a slope of intersection with the glideslope while having a slope lower than the glideslope. For example, according to one particular embodiment, it is advantageously possible to use higher deceleration rates for calculations dedicated to decelerations, so as to avoid the resulting slope being higher than the glideslope. Moreover, it is also possible to limit the slope determined for the constant-speed portions to a maximum value (for example to the value of the glideslope). However, such limitations may vary depending on the deployment configuration in question of the drag-increasing devices. Indeed, drag differs depending on this configuration, this then having an impact on the risk of computationally determining steep slopes.

### Regarding the So-Called “Very High-Energy” Segment Modification Strategy

This strategy make be broken down into two steps. In this strategy, it is necessary to maintain a maximum speed for as long as possible and then decelerate efficiently. For this purpose, deployment of drag-increasing devices is used over at least one constant-speed segment portion in addition to being used over all deceleration portions. Indeed, a deceleration that is both late and efficient makes it possible to maximize drag (which increases with speed) prior to the deceleration, and therefore minimizes the need for additional drag. A first segment portion is determined to have a nominal deceleration rate, and then, if this proves insufficient, a minimum deceleration rate is used to address local slopes of up to 3.5°. If this still does not prove sufficient, a so-called “path too steep” strategy is used.

### Regarding the So-Called “Path Too Steep” Segment Modification Strategy

This strategy uses a deployment of drag-increasing devices at 50% of their maximum deployment throughout the duration of the segment in question and a deceleration less than that desired is carried out. This then minimizes the residual jump in height Δh at the junction between two neighbouring segments of the profile, which jump will have to be cancelled out when processing the following segment in accordance with the method (therefore the previous descent profile segment when the descent is conducted).

Advantageously, the results of applying each of the local strategies for modifying (correcting) the initial continuous descent profile PI respectively result in modified continuous descent profile portions so as to obtain an intermediate profile P2.

According to one embodiment, these concatenated modified profile portions make it possible to arrive at the intermediate profile P2 to be subsequently validated by more precise calculation in order to obtain a final continuous descent profile FP that is then used to control the descent trajectory of the aircraft in question.

FIG. 7 is a flowchart illustrating the steps of a method for determining a segmented continuous descent profile according to one particular and non-limiting embodiment of the invention.

According to this embodiment, a step S0 corresponds to an initialization step at the end of which an aircraft carrying on board a device for determining a continuous descent profile is cruising. All of the aircraft systems are thus configured and operating nominally so as to carry out the various flight phases in accordance with the various flight procedures. During step S0, the aircraft obtains all data useful for determining the first continuous descent profile PI. In particular, the aircraft obtains meteorological information comprising wind directions and speeds at points regularly spaced along the overall trajectory of the current flight. For example, the aircraft obtains the wind speed and direction(s) on the ground, at an altitude of 2000 feet, 5000 feet, 7000 feet, etc., and the temperatures at these various altitudes.

The aircraft 6 also possesses information relating to approach and arrival procedures, in particular by virtue of pre-recording waypoints, which are located in space in terms of geographical coordinates and altitude. In addition, the aircraft possesses information relating to its overall nominal or measured performance (including as a function of fuel weight), and other information specific to the destination airport facilities. For example, the aircraft 6 possesses all the elements specific to each of the possible arrival procedures, holding loops, etc. depending on the configuration of the destination airport facilities (number of runways, runway orientations, use of the facilities, availability of air traffic control services). These examples of information are not limiting.

In a step S1, and based on the obtained information, and in particular the speed constraints imposed by the approach procedure published for the chosen or imposed approach, the device for determining a continuous descent profile of the aircraft determines descent profile segments such that the boundaries of each of the segments correspond to speed constraints defined by the approach procedure.

According to one variant embodiment, the altitude constraints are considered for this segmentation, meaning that, if an altitude constraint seems a priori (at first sight) to be difficult, very difficult or even impossible to comply with given the speed constraints delimiting a segment, then the segment is extended more widely, and for example to the next speed constraint so as to resolve conformities of altitude constraints more easily through the simplified calculations to be carried out. In other words, this is tantamount to combining two neighbouring segments of a descent profile into a single segment, since a first level of analysis has shown that this makes it possible to simplify the calculations to be carried out, by reducing the margins between the trajectory of the airliner and the constraints not complied with a priori, according to the initial continuous descent profile PI.

Next, and for each of the determined segments of the initial continuous descent profile PI, the device for determining a descent profile determines, in a step S2, the energy level category to which the segment corresponds. For this purpose, the variation in altitude between the two ends of the segment is calculated, along with the differences in altitude between the altitude constraints and the profile before modification (that is to say the profile PI). The device for determining a continuous descent profile then determines whether the segment to be processed is a “low-energy”, “high-energy”, “very high-energy”, or slope too steep, etc. segment or the variants thereof to satisfy all constraints.

As soon as a segment is categorized in this way, the device for determining a continuous descent profile processes the segment and modifies it, in step S2, if necessary. For example, estimates of variations in altitude and variations in speed are made sequentially in order to determine the best combinations of modifying the initial profile PI to satisfy all constraints or at the very least a maximum number of constraints, while still satisfying criteria concerning piloting and sensation for the occupants of the aircraft in question. Ideally, the variations should not be too abrupt, for example, just as descent slopes should not be too steep in order to avoid unwanted increases in the speed of the aircraft.

The segments are therefore processed sequentially starting from the end point A and going back up the initial continuous descent profile PI while modifying it. Modification of a segment results, or may result, in a jump in height (or altitude) Δh at the boundary between two neighbouring segments, which jump in height must then be resolved in full or in part when processing the following segment by going back in the continuous descent profile PI. Finally, when all of the determined segments have been processed by the device for determining a continuous descent profile, the modified profile, called profile P2 here, is validated, in a step S3, by a single final phase of precise calculations carried out using a dedicated or non-dedicated avionics computer, and which then verifies that all the modifications that have been made make it possible to obtain a satisfactory final continuous descent profile FP towards the end point A.

According to one embodiment, in the opposite case, that is to say if the profile has at least one incompatibility, this incompatibility may be processed during this final calculation phase.

According to one variant, if the final profile FP has at least one incompatibility, the method is carried out again and information representative of the detected incompatibility is stored in order to be used subsequently when the method is carried out again.

According to another variant, if the final profile FP has at least one incompatibility, information is provided and made available to flight personnel, in order to locally process this incompatibility, for example, with the agreement of air traffic control operators.

If the determined final continuous descent profile FP is satisfactory, information is supplied by the device for determining a continuous descent profile, in a step S4, for the purpose of controlling the descent trajectory of the aircraft.

According to one embodiment, this information is transmitted to one or more avionics modules configured to pilot the aircraft.

According to another embodiment, this information is transmitted to the aircraft flight crew so that the crew uses said information for the purpose of piloting the aircraft, and therefore for controlling the descent trajectory towards the end point A of the aircraft.

FIG. 5 schematically illustrates one example of an internal architecture of the device 100 for determining a continuous descent profile. It should be noted that FIG. 5 could also schematically illustrate one example of a hardware architecture of an autopilot device of an aircraft configured to carry out functions of determining a continuous descent profile and to control the thrust of the engines of this aircraft and the activation of drag-increasing devices of this aircraft, such as aerobrakes for example.

According to the exemplary hardware architecture shown in FIG. 5, the device 100 for determining a continuous descent profile then comprises the following, connected by a communication bus 190: a processor or central processing unit (CPU) 101; a random access memory (RAM) 102; a read-only memory (ROM) 103; a storage unit such as a hard disk (or a storage media reader such as an SD (Secure Digital) card reader) 104; at least one communication interface 105 enabling the configuration device 100 to communicate with remote devices, such as for example an autopilot device to which it is connected or one or more devices for controlling the thrust of the engines of the aircraft carrying the device 100 on board, or else one or more drag-increasing devices of this aircraft.

According to one embodiment, the read-only memory of the device 100 for determining a continuous descent profile comprises tables and matrices of information and data capable of carrying out simplified and fast descent trajectory calculations, including using a backward integration method for movements and displacements of the aircraft, in particular by carrying out calculations of affine functions and calculations of intersections of straight lines in a calculation space expressing heights (or latitudes) of the aircraft as a function of its displacement along a horizontal trajectory. In other words, these data and information constitute calculation templates and charts for carrying out fast and sufficiently precise calculations when determining local strategies (per segment and subsegment of the continuous descent profile), all while considering, if necessary, weights determined from obtained data representative of the flight conditions (temperature, wind force and direction, heading, etc.).

The processor 101 is capable of executing instructions loaded into the RAM 102 from the ROM 103, from an external memory (not shown), from a storage medium (such as an SD card), or from a communication network. When the device 100 for determining a continuous descent profile is powered on, the processor 101 is capable of reading instructions from the RAM 102 and of executing them. These instructions form a computer program that causes the processor 101 to implement part of a method described with reference to FIG. 7.

All or part of the method implemented by the device 100 for determining a continuous descent profile, or its described variants, may be implemented in software form via execution of a set of instructions by a programmable machine constituting a program product, for example a digital signal processor (DSP) or a microcontroller, or be implemented in hardware form by a dedicated machine or component, for example a field-programmable gate array (FPGA) or an application-specific integrated circuit (ASIC). Generally speaking, the device 100 for determining a continuous descent profile comprises electronic circuitry configured to implement the method described in relation to itself and to the devices to which it is connected, such as for example an autopilot device, and any other device involved in the execution of the described configuration method. Of course, the device 100 for determining a continuous descent profile also comprises all of the elements that are usually present in a system comprising a control unit and its peripherals, such as a power supply circuit, a power supply supervision circuit, one or more clock circuits, a zeroing circuit, input/output ports, interrupt inputs and bus drivers, this list not being exhaustive.

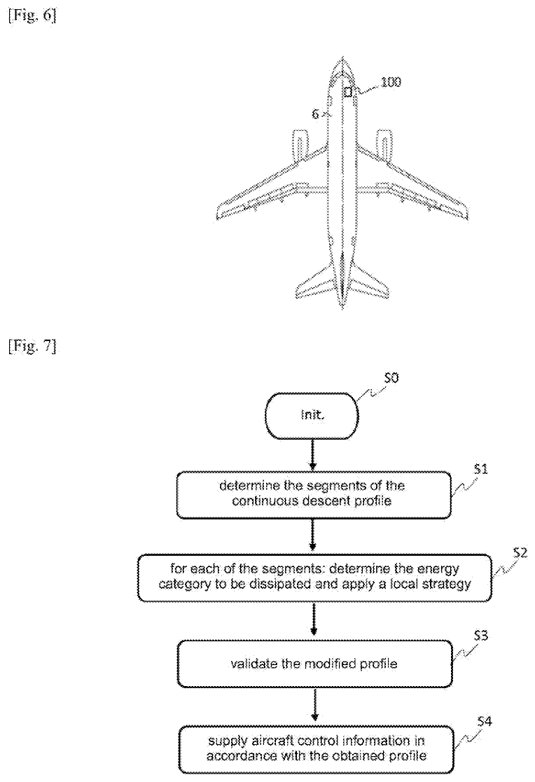

FIG. 6 illustrates an aircraft 6 comprising the device 100 for determining a continuous descent profile. Using the device 100 for determining a continuous descent profile, configured to carry out the described method or any one of its variants, it is advantageously possible for the aircraft 6 carrying it on board to determine a continuous descent profile that satisfies all of the speed and altitude constraints imposed on this aircraft conducting a flight approaching and arriving at airport facilities.

Advantageously, the aircraft 6 may carry the device 100 for determining the continuous descent profile or a similar device on board, in its flight control equipment, coupled directly or indirectly to a navigation and autopilot device or system.

1. A method for determining a continuous descent profile for an aircraft towards a point of an arrival procedure referred to as an “arrival point”, said method comprising:
i) determining segments of an initial continuous descent profile based on at least the arrival point, predefined speed constraints and theoretical data concerning the evolution of the aircraft conducting a flight with minimum engine thrust,
ii) categorizing each of said determined segments of said initial profile among a plurality of predetermined energy level categories, based on at least said predefined speed constraints and altitude constraints, and
iii) determining, for each of said categorized segments, a local strategy for modifying said initial continuous descent profile, based on an energy category assigned to the segment in question, said local strategy aiming to determine, if necessary, times at which to increase the thrust and/or drag of said aircraft.

2. The method for determining a continuous descent profile according to claim 1, said method furthermore comprising, following the determination of a local strategy for each of the segments:
iv) computationally determining a final continuous descent profile according to the concatenated results of said determined local strategies respectively applied to said segments, for the purpose of detecting the absence of incompatibility between the determined final continuous descent profile and at least one of said predefined speed constraints or altitude constraints, and then,
v) in the absence of incompatibility between the determined final continuous descent profile and at least one of said predefined speed constraints or altitude constraints, controlling a trajectory of said aircraft in accordance with said final continuous descent profile or providing piloting information representative of piloting actions to be carried out to conduct a continuous descent in accordance with the final continuous descent profile.

3. The method for determining a continuous descent profile according to claim 1, wherein at least three local strategies for modifying a descent profile are predefined, including:
a) a first strategy, called “low-energy” strategy, involves maintaining the speed of the aircraft with engine thrust applied while traversing a segment portion less than the length of the segment in question,
b) a second strategy, called “high-energy” strategy, involves activating drag-increasing devices only during a deceleration portion less than the length of the segment in question,
c) a third local strategy, called “very high-energy” strategy, involves activating drag-increasing devices during a portion of the segment in question greater than the deceleration portion.

4. The method for determining a continuous descent profile according to claim 3, wherein at least four local strategies for modifying a descent profile are predefined, including a fourth local strategy, which involves activating drag-increasing devices during a portion of the segment in question greater than the deceleration portion and less than or equal to the length of the segment.

5. The method for determining a continuous descent profile according to claim 4, wherein at least five local strategies for modifying a descent profile are predefined, including a fifth local strategy, which involves activating drag-increasing devices throughout the length of the segment in question and reducing the deceleration to less than that desired for said segment in question.

6. A device for determining a continuous descent profile for an aircraft, the device comprising electronic circuitry configured to:
i) determine segments of an initial continuous descent profile based on at least the arrival point, predefined speed constraints and theoretical data concerning the evolution of the aircraft conducting a flight with minimum engine thrust,
ii) categorize each of said determined segments of said initial profile among a plurality of predetermined energy level categories, based on at least said predefined speed constraints and altitude constraints, and
iii) determine, for each of said categorized segments, a local strategy for modifying said initial continuous descent profile, based on an energy category assigned to the segment in question, said local strategy aiming to determine, if necessary, times at which to increase the thrust and/or drag of said aircraft.

7. The device for controlling a continuous descent trajectory of an aircraft according to claim 6, the device furthermore comprising electronic circuitry configured to:
iv) computationally determine a final continuous descent profile according to the concatenated results of said determined local strategies, for the purpose of detecting the absence of incompatibility between the determined final continuous descent profile and at least one of said predefined speed constraints or altitude constraints, and then,
v) in the absence of incompatibility between the determined final continuous descent profile and at least one of said predefined speed constraints or altitude constraints, control a trajectory of said aircraft in accordance with said final continuous descent profile or provide piloting information representative of piloting actions to be carried out to conduct a continuous descent in accordance with the final continuous descent profile.

8. An autopilot system for an aircraft comprising a control device according to claim 6.

9. An aircraft comprising the autopilot system for the aircraft according to claim 8.

10. (canceled)

11. A non-transitory storage medium comprising a computer program product comprising instructions for carrying out the method according to claim 1, when said instructions are executed by a processor of an aircraft control device.

12. An aircraft comprising the control device according to claim 6.
